(19) United States
(12) Patent Application Publication
(10) Pub. No.: US 2014/0306552 A1
(43) Pub. Date: Oct. 16, 2014

(54) POWER TRANSMISSION SYSTEM

(71) Applicant: Murata Manufacturing Co., Ltd., Nagaokakyo-shi (JP)

(72) Inventors: Shinji Goma, Nagaokakyo-shi (JP); Tsutomu Ieki, Nagaokakyo-shi (JP)

(21) Appl. No.: 14/315,921

(22) Filed: Jun. 26, 2014

Related U.S. Application Data
(63) Continuation of application No. PCT/JP2012/075363, filed on Oct. 1, 2012.

(30) Foreign Application Priority Data
Jan. 10, 2012 (JP) 2012-002089

(51) Int. Cl. H04B 5/00

(52) U.S. Cl. CPC H04B 5/0012; H04B 5/0037; H04B 5/0031
USPC 307/149

(57) ABSTRACT

A power transmission system is provided which is able to perform stable data communication with high communication sensitivity even when data communication and power transmission are performed at the same time.

At least a third coupling electrode pair of first to third coupling electrode pairs is a reference electrode pair connected to a reference potential, one end of a first communication portion is connected to a reference potential of a power transmitting apparatus, and one end of a second communication portion is connected to a reference potential of a power receiving apparatus. Another end of the first communication portion is connected to either one of a power transmitting apparatus-side first or second coupling electrode, and another end of the second communication portion is connected to either one of a power receiving apparatus-side first or second coupling electrode.

### CROSS REFERENCE TO RELATED APPLICATIONS

The present application is a continuation of PCT/JP2012/075363 filed Oct. 1, 2012, which claims priority to Japanese Patent Application No. 2012-002089, filed Jan. 10, 2012, the entire contents of each of which are incorporated herein by reference.

### FIELD OF THE INVENTION

The present invention relates to a power transmission system which transmits power without physical connection. In particular, the present invention relates to a power transmission system which is usable for both electric field coupling type power transmission and data communication.

### BACKGROUND OF THE INVENTION

In recent years, many electronic apparatuses have been developed which transmit power in a noncontact manner. Noncontact data communication in an electronic apparatus is enabled to be performed easily via a wireless LAN or the like. However, in consideration of security in data communication, an apparatus has also been developed which enables data communication to be performed only when an electronic apparatus is placed at a predetermined location.

For example, in a power supply (transmission) system disclosed in Patent Document 1, a power source is provided in a fixed body (a power transmitting apparatus), a load circuit is provided in a movable body (a power receiving apparatus), and a communication portion is provided in parallel with each of the power source and the load circuit. FIG. 9 is a schematic circuit diagram showing arrangement of communication portions in an existing power transmission system.

In FIG. 9, a power transmitting apparatus 1 and a power receiving apparatus 2 are coupled via an electric field to each other at a first coupling electrode pair 10a and a second coupling electrode pair 10b. One end of a first communication portion 13 of the power transmitting apparatus 1 is connected to one end of a voltage generation circuit (power source) 12. Another end of the first communication portion 13 of the power transmitting apparatus 1 is connected via a coupler to a power line leading to the first coupling electrode pair 10a. One end of a second communication portion 23 of the power receiving apparatus 2 is connected to a load circuit 24. Another end of the second communication portion 23 of the power receiving apparatus 2 is connected via a coupler to a power line leading to the first coupling electrode pair 10a.

The power receiving apparatus 2 receives AC power from the power transmitting apparatus 1 via the first and second coupling electrode pairs 10a and 10b, converts the AC power to DC power by a rectifying circuit 22, and supplies the DC power to the load circuit 24. In the power receiving apparatus 2, one end of the load circuit 24 is grounded so as to have a reference potential. For example, the one end of the load circuit 24 is connected to, for example, a ground electrode (ground pattern) of a circuit board, a shield portion (shield case) of a housing of the power receiving apparatus 2, or the like. The first communication portion 13 and the second communication portion 23 are allowed to communicate with each other by the first coupling electrode pair 10a and the second coupling electrode pair 10b being coupled via an electric field to each other. Thus, it is possible to perform power transmission and data communication at the same time.
Patent Document 1: Japanese Unexamined Patent Application Publication No. 2009-089520

However, in the case where, as shown in FIG. 9, the first communication portion 13 and the second communication portion 23 are provided in parallel with the power generation circuit (power source) 12 of the power transmitting apparatus 1 and the load circuit 24 of the power receiving apparatus 2, respectively, a high-voltage power signal is directly modulated. Therefore, when power is changed for some reason, the levels of signals inputted into the first communication portion 13 and the second communication portion 23 are greatly changed. Thus, there is the problem that noise is likely to be mixed in the signals and it is difficult to perform stable data communication with high communication sensitivity.

### SUMMARY OF THE INVENTION

The present invention has been made in view of the above-described circumstances, and it is an object of the present invention to provide a power transmission system which is able to perform stable data communication with high communication sensitivity even when data communication and power transmission are performed at the same time.

In order to attain the above-described object, a power transmission system according to the present invention includes: a power transmitting apparatus including power transmitting apparatus-side first to third coupling electrodes, a voltage generation circuit connected between the first coupling electrode and the second coupling electrode, and a first communication portion capable of performing data communication; and a power receiving apparatus including power receiving apparatus-side first to third coupling electrodes, a load circuit connected between the first coupling electrode and the second coupling electrode, and a second communication portion capable of performing data communication, the power transmission system forming first to third coupling electrode pairs by the power transmitting apparatus-side first to third coupling electrodes and the power receiving apparatus-side first to third coupling electrodes, the power transmission system transmitting power by capacitive coupling. At least the third coupling electrode pair of the first to third coupling electrode pairs is a reference electrode pair connected to a reference potential. One end of the first communication portion is connected to a reference potential of the power transmitting apparatus and one end of the second communication portion is connected to a reference potential of the power receiving apparatus. Another end of the first communication portion is connected to either one of the power transmitting apparatus-side first or second coupling electrode and another end of the second communication portion is connected to either one of the power receiving apparatus-side first or second coupling electrode.

In the above configuration, since the third coupling electrode pair, which is the reference electrode pair, is provided independently of the first coupling electrode pair and the second coupling electrode pair for power transmission and the one end of the first communication portion of the power transmitting apparatus and the one end of the second communication portion of the power receiving apparatus are connected to the reference potentials of the power transmitting apparatus and the power receiving apparatus, respectively, it is possible to greatly reduce change in reference potentials of the first communication portion and the second communication portion at the time of power transmission, and it is possible to increase the SN ratio (signal-to-noise ratio) of a communication signal. Therefore, it is possible to increase the communication sensitivity and to further stabilize the data communication.

In addition, in the power transmission system according to the present invention, the reference potential of the power transmitting apparatus is preferably a ground potential.

In the above configuration, since the reference potential of the power transmitting apparatus is the ground potential, the reference potential is constant, it is further less subject to influence of potential variation at the time of power transmission, and it is possible to perform more stable data communication at the same time as power transmission.

In addition, in the power transmission system according to the present invention, preferably, the one end of the first communication portion is connected to the power transmitting apparatus-side third coupling electrode, and the one end of the second communication portion is connected to the power receiving apparatus-side third coupling electrode.

According to the above configuration, since the one end of the first communication portion is connected to the power transmitting apparatus-side third coupling electrode and the one end of the second communication portion is connected to the power receiving apparatus-side third coupling electrode, it is possible to assuredly set the one end of the first communication portion and the one end of the second communication portion at the reference potentials, it is less subject to influence of potential variation at the time of power transmission, and it is possible to perform stable data communication at the same time as power transmission. In addition, since a portion of each electrode for power transmission is also used for data communication, it is possible to reduce the sizes of the apparatuses, and it is possible to perform stable data communication at the same time as power transmission.

In addition, in the power transmission system according to the present invention, preferably, the other end of the first communication portion is connected to either one of the power transmitting apparatus-side first or second coupling electrode via a coupler, and the other end of the second communication portion is connected to either one of the power receiving apparatus-side first or second coupling electrode via a coupler.

In the above configuration, since the other end of the first communication portion is connected to either one of the power transmitting apparatus-side first or second coupling electrode via the coupler and the other end of the second communication portion is connected to either one of the power receiving apparatus-side first or second coupling electrode via the coupler, it is possible to perform relatively stable data communication even in the case with a symmetrical configuration in which each of the first and second coupling electrode pairs serves as active electrodes having a high potential.

In addition, in the power transmission system according to the present invention, preferably, the other end of the first communication portion is connected via a coupler to a low-potential coupling electrode of the power transmitting apparatus-side first or second coupling electrode, and the other end of the second communication portion is connected via a coupler to a low-potential coupling electrode of the power receiving apparatus-side first or second coupling electrode.

In the above configuration, since the other end of the first communication portion is connected to either one of the power transmitting apparatus-side first or second coupling electrode via the coupler and the other end of the second communication portion is connected to either one of the power receiving apparatus-side first or second coupling electrode via the coupler, it is possible to perform relatively stable data communication even in the case where the coupling electrodes have an asymmetrical configuration. In addition, since the other end of the first communication portion is connected via the coupler to the low-potential coupling electrode of the power transmitting apparatus-side first or second coupling electrode and the other end of the second communication portion is connected via the coupler to the low-potential coupling electrode of the power receiving apparatus-side first or second coupling electrode, the first communication portion and the second communication portion are further less subject to influence of potential variation at the time of power transmission, and it is possible to perform more stable data communication at the same time as power transmission.

In the power transmission system according to the present invention, since the third coupling electrode pair, which is the reference electrode pair, is provided independently of the first coupling electrode pair and the second coupling electrode pair for power transmission and the one end of the first communication portion of the power transmitting apparatus and the one end of the second communication portion of the power receiving apparatus are connected to the reference potentials of the power transmitting apparatus and the power receiving apparatus, respectively, it is possible to greatly reduce change in the reference potentials of the first communication portion and the second communication portion at the time of power transmission, and it is possible to increase the SN ratio (signal-to-noise ratio) of a communication signal. Therefore, it is possible to increase the communication sensitivity and to further stabilize the data communication.

### BRIEF DESCRIPTION OF DRAWINGS

FIG. 1 is a schematic circuit diagram showing a configuration of a power transmission system according to Embodiment 1 of the present invention.

FIG. 2 is a schematic circuit diagram showing a configuration of a power transmission system according to Embodiment 2 of the present invention.

FIG. 3 is a schematic circuit diagram showing another configuration of a power transmission system according to Embodiment 2 of the present invention.

FIG. 4 is a schematic circuit diagram showing a configuration of a power transmission system according to Embodiment 3 of the present invention.

FIG. 5 is a schematic circuit diagram showing another configuration of a power transmission system according to Embodiment 3 of the present invention.

FIG. 6 is a schematic circuit diagram showing still another configuration of a power transmission system according to Embodiment 3 of the present invention.

FIG. 7 is a schematic diagram showing a configuration of a smartphone used as a power receiving apparatus of a power transmission system according to Embodiment 4 of the present invention.

FIG. 8 is a longitudinal cross-sectional view schematically showing configurations of a power transmitting apparatus and the power receiving apparatus of the power transmission system according to Embodiment 4 of the present invention.

FIG. 9 is a schematic circuit diagram showing arrangements of communication portions in an existing power transmission system.

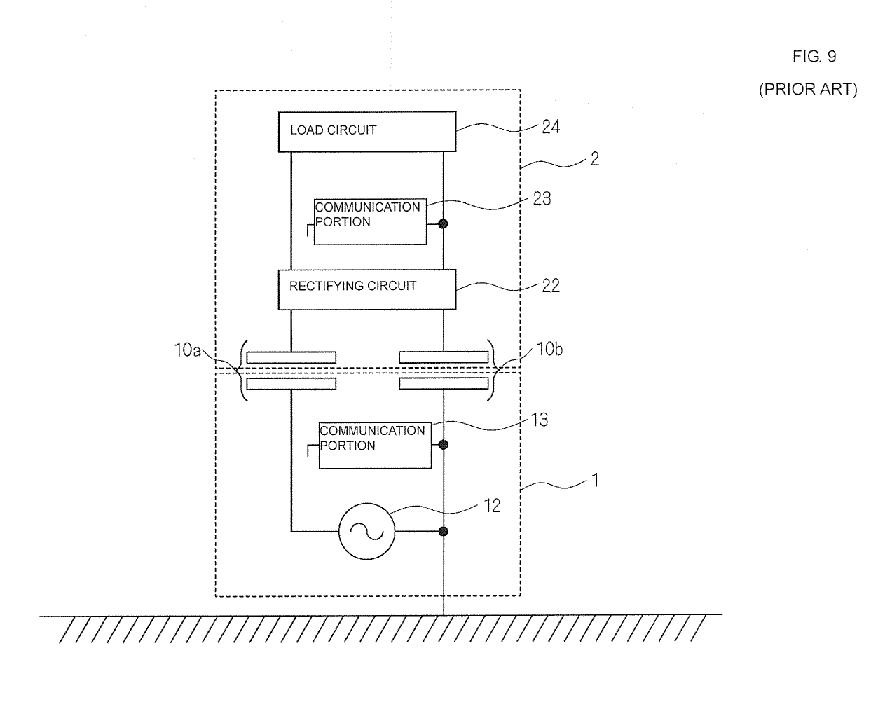

### DETAILED DESCRIPTION OF THE PREFERRED EMBODIMENTS

Hereinafter, power transmission systems according to embodiments of the present invention and power transmitting apparatuses and power receiving apparatuses used in the power transmission systems will be specifically described with reference to the drawings. The embodiments described below do not limit the invention described in the claim and all the combinations of features described in the embodiments are not necessarily essential to means for solving the problems.

### Embodiment 1

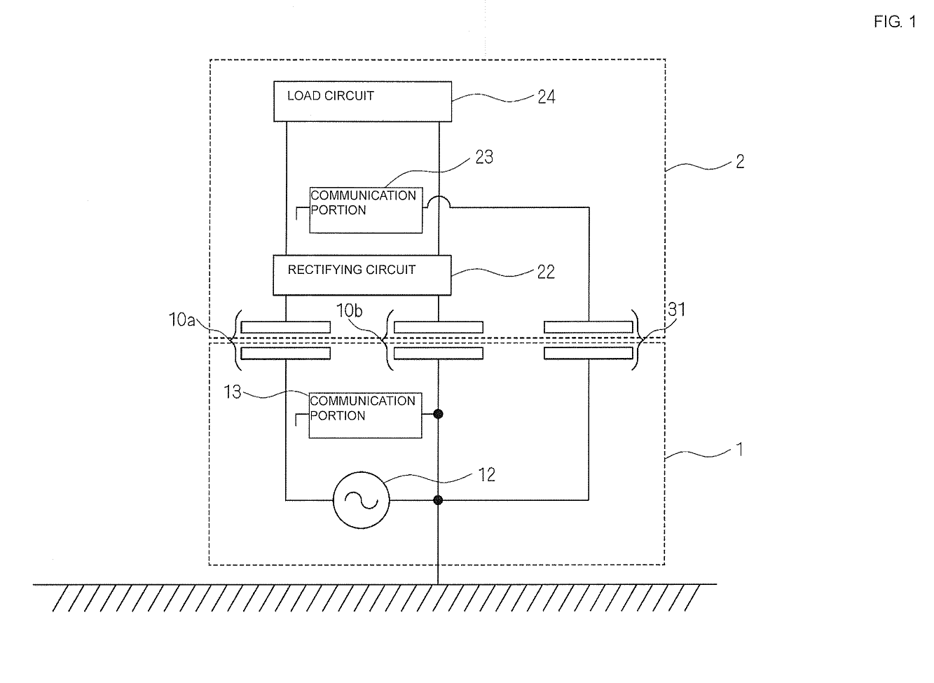

FIG. 1 is a schematic circuit diagram showing a configuration of a power transmission system according to Embodiment 1 of the present invention. As shown in FIG. 1, a power transmitting apparatus 1 of the power transmission system according to Embodiment 1 includes at least a voltage generation circuit 12, a power transmission module portion including an amplifier and a step-up transformer which are not shown, and power transmitting apparatus 1-side first to third coupling electrodes forming first to third coupling electrode pairs 10a, 10b, and 31. In addition, a power receiving apparatus 2 includes at least a power reception module portion including a step-down transformer which is not shown, a rectifying circuit 22, and a load circuit 24, and power receiving apparatus 2-side first to third coupling electrodes forming the first to third coupling electrode pairs 10a, 10b, and 31.

The voltage generation circuit 12 of the power transmission module portion of the power transmitting apparatus 1 generates an AC voltage having a frequency of 10 kHz to 10 MHz, and the generated AC voltage is stepped up to 100 V to 10 kV by the step-up transformer which is not shown. The stepped-up AC voltage is transmitted in a noncontact manner by capacitive coupling at the first and second coupling electrode pairs 10a and 10b. The transmitted AC voltage is stepped down by the step-down transformer of the power reception module portion of the power receiving apparatus 2 and converted to a DC voltage via the rectifying circuit 22, and the DC power is supplied to the load circuit 24.

In Embodiment 1, in addition to the first coupling electrode pair 10a and the second coupling electrode pair 10b which are used for power transmission, the third coupling electrode pair 31 is provided as a reference electrode pair connected to a reference potential. Of the third coupling electrode pair 31, the power transmitting apparatus 1-side third coupling electrode is connected to a reference potential (ground potential) of the power transmitting apparatus 1, and the power receiving apparatus 2-side third coupling electrode is connected to a reference potential of the power receiving apparatus 2, for example, a ground electrode of a circuit board of the power receiving apparatus 2, a shield portion of a housing of the power receiving apparatus 2, or the like.

A first communication portion 13 of the power transmitting apparatus 1 is connected at one end thereof to the second coupling electrode pair 10b and is connected at another end thereof to the first coupling electrode pair 10a via a coupler. The power transmitting apparatus 1-side second coupling electrode of the second coupling electrode pair 10b is connected to the reference potential (ground potential) of the power transmitting apparatus 1. In other words, the one end of the first communication portion 13 is connected to the reference potential of the power transmitting apparatus 1.

A second communication portion 23 of the power receiving apparatus 2 is connected at one end thereof to the third coupling electrode pair 31 and is connected at another end thereof between the rectifying circuit 22, connected to the first coupling electrode pair 10a, and the load circuit 24 via a coupler. The power receiving apparatus 2-side third coupling electrode of the third coupling electrode pair 31 is connected to the reference potential of the power receiving apparatus 2, for example, the ground electrode of the circuit board of the power receiving apparatus 2, the shield portion of the housing of the power receiving apparatus 2, or the like. In other words, the one end of the second communication portion 23 is connected to the reference potential of the power receiving apparatus 2. It should be noted that in Embodiment 1, since the reference potential of the power transmitting apparatus 1 is the ground potential, the reference potential is constant, it is further less subject to influence of potential variation at the time of power transmission, and it is possible to perform more stable data communication at the same time as power transmission.

Power transmission is performed via the first coupling electrode pair 10a and the second coupling electrode pair 10b. Since the one end of the first communication portion 13 and the one end of the second communication portion 23 are connected to the reference potentials as described above, it is possible to greatly reduce change in the reference potentials of the first communication portion 13 and the second communication portion 23 at the time of power transmission, and it is possible to increase the SN ratio of a communication signal. Therefore, it is possible to increase the communication sensitivity and to further stabilize the data communication.

As described above, according to Embodiment 1, the third coupling electrode pair 31, which is the reference electrode pair, is provided independently of the first coupling electrode pair 10a and the second coupling electrode pair 10b for power transmission, and the one end of the first communication portion 13 of the power transmitting apparatus 1 and the one end of the second communication portion 23 of the power receiving apparatus 2 are connected to the reference potentials of the power transmitting apparatus 1 and the power receiving apparatus 2, respectively. Thus, it is possible to greatly reduce change in the reference potentials of the first communication portion 13 and the second communication portion 23 at the time of power transmission, and it is possible to increase the SN ratio of a communication signal. Therefore, it is possible to perform stable data communication at the same time as power transmission.

### Embodiment 2

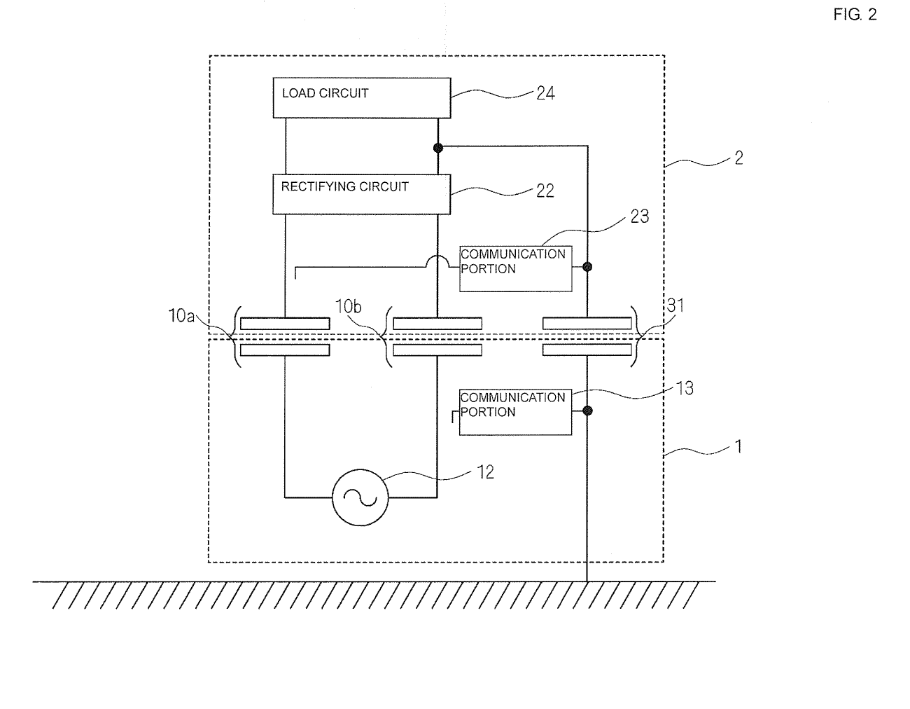

FIG. 2 is a schematic circuit diagram showing a configuration of a power transmission system according to Embodiment 2 of the present invention. As shown in FIG. 2, a power transmitting apparatus 1 of the power transmission system according to Embodiment 2 includes at least a voltage generation circuit 12, a power transmission module portion including an amplifier and a step-up transformer which are not shown, and power transmitting apparatus 1-side first to third coupling electrodes forming first to third coupling electrode pairs 10a, 10b, and 31. In addition, a power receiving apparatus 2 includes at least a power reception module portion including a step-down transformer which is not shown, a rectifying circuit 22, and a load circuit 24, and power receiving apparatus 2-side first to third coupling electrodes forming the first to third coupling electrode pairs 10a, 10b, and 31.

In Embodiment 2, similarly to Embodiment 1, in addition to the first coupling electrode pair 10a and the second coupling electrode pair 10b which are used for power transmission, the third coupling electrode pair 31 is provided as a reference electrode pair connected to a reference potential. Of the third coupling electrode pair 31, the power transmitting apparatus 1-side third coupling electrode is connected to a reference potential (ground potential) of the power transmitting apparatus 1, and the power receiving apparatus 2-side third coupling electrode is connected to a reference potential of the power receiving apparatus 2, for example, a ground electrode of a circuit board of the power receiving apparatus 2, a shield portion of a housing of the power receiving apparatus 2, or the like.

A first communication portion 13 of the power transmitting apparatus 1 is connected at one end thereof to the third coupling electrode pair 31 and is connected at another end thereof to the second coupling electrode pair 10b via a coupler. Unlike Embodiment 1, the power transmitting apparatus 1-side second coupling electrode of the second coupling electrode pair 10b is not connected to the reference potential (ground potential) of the power transmitting apparatus 1, and the power transmitting apparatus 1-side third coupling electrode of the third coupling electrode pair 31 is connected to the reference potential (ground potential) of the power transmitting apparatus 1.

A second communication portion 23 of the power receiving apparatus 2 is connected at one end thereof to the third coupling electrode pair 31 and is connected at another end via a coupler to the first coupling electrode pair 10a before the rectifying circuit 22. The other end of the second communication portion 23 may be connected to the second coupling electrode pair 10b via a coupler. The power receiving apparatus 2-side third coupling electrode of the third coupling electrode pair 31 is connected to the reference potential of the power receiving apparatus 2, for example, the ground electrode of the circuit board of the power receiving apparatus 2, the shield portion of the housing of the power receiving apparatus 2, or the like.

The voltage generation circuit 12 of the power transmitting apparatus 1 performs a balanced operation, and the power transmitting apparatus 1-side first coupling electrode of the first coupling electrode pair 10a and the power transmitting apparatus 1-side second coupling electrode of the second coupling electrode pair 10b are not connected to the reference potential of the power transmitting apparatus 1. Therefore, even when power transmission is performed at a high voltage, the reference potential of the third coupling electrode pair 31 is more stable than that in the power transmission system according to Embodiment 1.

Power transmission is performed via the first coupling electrode pair 10a and the second coupling electrode pair 10b. Since the one end of the first communication portion 13 and the one end of the second communication portion 23 are connected to the reference potentials as described above, it is possible to greatly reduce change in the reference potentials of the first communication portion 13 and the second communication portion 23 at the time of power transmission, and it is possible to increase the SN ratio of a communication signal. Therefore, it is possible to increase the communication sensitivity and to further stabilize the data communication.

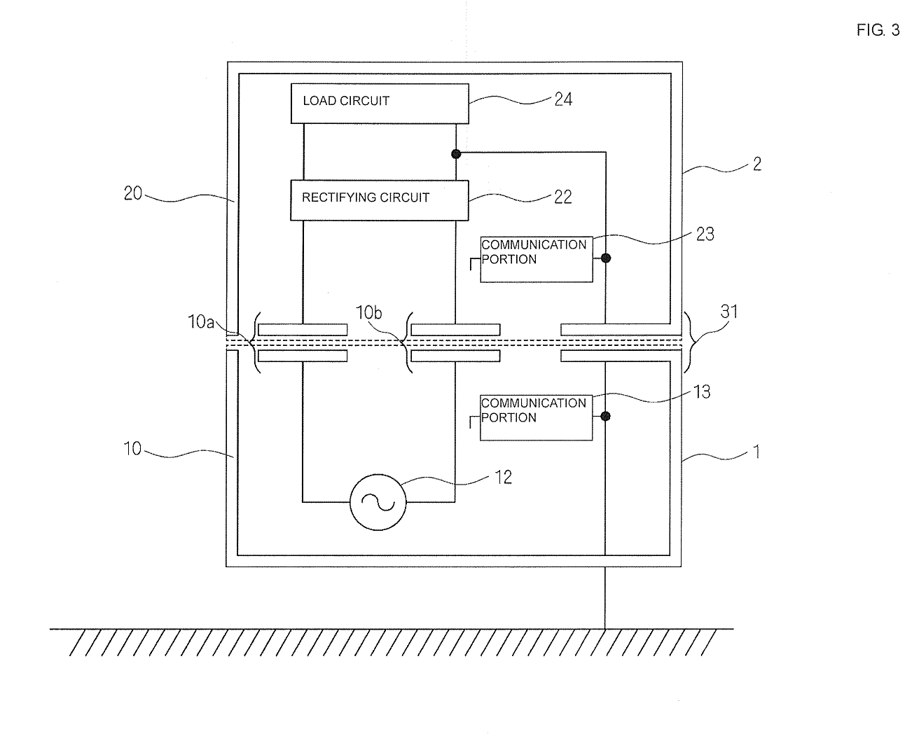

FIG. 3 is a schematic circuit diagram showing another configuration of a power transmission system according to Embodiment 2 of the present invention. In FIG. 3, a housing 10 of the power transmitting apparatus 1 and a housing 20 of the power receiving apparatus 2 are used as a shield case (a shield portion) for grounding, and the third coupling electrode pair 31, which serves as a reference electrode pair connected to the reference potential, is formed as a portion of the housing 10 of the power transmitting apparatus 1 and a portion of the housing 20 of the power receiving apparatus 2.

The voltage generation circuit 12 of the power transmitting apparatus 1 performs a balanced operation, and the power transmitting apparatus 1-side first coupling electrode of the first coupling electrode pair 10a and the power transmitting apparatus 1-side second coupling electrode of the second coupling electrode pair 10b are not connected to the reference potential of the power transmitting apparatus 1. Therefore, even when power transmission is performed at a high voltage, the reference potential of the third coupling electrode pair 31 is more stable than that in the power transmission system according to Embodiment 1.

Since the third coupling electrode pair 31 is not independently provided and is formed as a portion of the housing 10 of the power transmitting apparatus 1 and a portion of the housing 20 of the power receiving apparatus 2, it is possible to reduce the sizes of the power transmitting apparatus 1 and the power receiving apparatus 2. In addition, the third coupling electrode pair 31 may be located at any position that is within a region where it is possible to place the power receiving apparatus 2 on the power transmitting apparatus 1, and thus flexibility in design is greatly enhanced.

As described above, according to Embodiment 2, the third coupling electrode pair 31, which is the reference electrode pair, is provided independently of the first coupling electrode pair 10a and the second coupling electrode pair 10b for power transmission, and the one end of the first communication portion 13 of the power transmitting apparatus 1 and the one end of the second communication portion 23 of the power receiving apparatus 2 are connected to the reference potentials of the power transmitting apparatus 1 and the power receiving apparatus 2, respectively. Thus, it is possible to greatly reduce change in the reference potentials of the first communication portion 13 and the second communication portion 23 at the time of power transmission, and it is possible to increase the SN ratio of a communication signal. Therefore, it is possible to perform stable data communication at the same time as power transmission. It should be noted that in Embodiment 2, the example is shown in which the third coupling electrode pair 31 is coupled via an electric field, but the third coupling electrode pair 31 may be coupled to each other by direct contact. The potential difference created between the third coupling electrode pair 31 is small as compared to the first coupling electrode pair 10a and the second coupling electrode pair 10b, and thus there is no concern that arc discharge occurs due to the direct contact.

### Embodiment 3

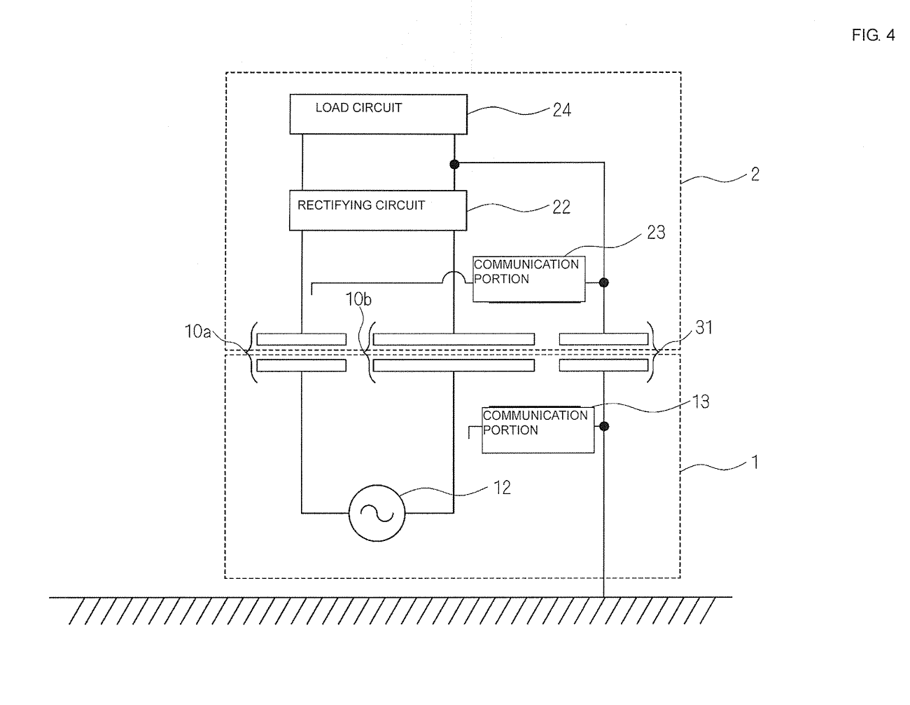

FIG. 4 is a schematic circuit diagram showing a configuration of a power transmission system according to Embodiment 3 of the present invention. As shown in FIG. 4, a power transmitting apparatus 1 of the power transmission system according to Embodiment 3 includes at least a voltage generation circuit 12, a power transmission module portion including an amplifier and a step-up transformer which are not shown, and power transmitting apparatus 1-side first to third coupling electrodes forming first to third coupling electrode pairs 10a, 10b, and 31. In addition, a power receiving apparatus 2 includes at least a power reception module portion including a step-down transformer which is not shown, a rectifying circuit 22, and a load circuit 24, and power receiving apparatus 2-side first to third coupling electrodes forming the first to third coupling electrode pairs 10a, 10b, and 31.

In Embodiment 3, similarly to Embodiment 2, in addition to the first coupling electrode pair 10a and the second coupling electrode pair 10b which are used for power transmission, the third coupling electrode pair 31 is provided as a reference electrode pair connected to a reference potential. Of the third coupling electrode pair 31, the power transmitting apparatus 1-side third coupling electrode is connected to a reference potential (ground potential) of the power transmitting apparatus 1, and the power receiving apparatus 2-side third coupling electrode is connected to a reference potential of the power receiving apparatus 2, for example, a ground electrode of a circuit board of the power receiving apparatus 2, a shield portion of a housing of the power receiving apparatus 2, or the like.

A first communication portion 13 of the power transmitting apparatus 1 is connected at one end thereof to the third coupling electrode pair 31 and is connected at another end thereof to the second coupling electrode pair 10b via a coupler. The power transmitting apparatus 1-side second coupling electrode of the second coupling electrode pair 10b is not connected to the reference potential of the power transmitting apparatus 1, and the power transmitting apparatus 1-side third coupling electrode of the third coupling electrode pair 31 is connected to the reference potential (ground potential) of the power transmitting apparatus 1. In addition, unlike Embodiment 2, the electrode area of the second coupling electrode pair 10b is larger than the electrode area of the first coupling electrode pair 10a. As a result, the potential of the second coupling electrode pair 10b is lower than the potential of the first coupling electrode pair 10a. In other words, an asymmetrical configuration is provided in which the first coupling electrode pair 10a having a relatively high potential serves as an active electrode pair, and the second coupling electrode pair 10b having a relatively low potential serves as a passive electrode pair. Due to such an asymmetrical configuration, it is possible to enhance flexibility in electrode design as compared to the case with a symmetrical configuration in which each of the first coupling electrode pair 10a and the second coupling electrode pair 10b serves as an active electrode pair having a high potential.

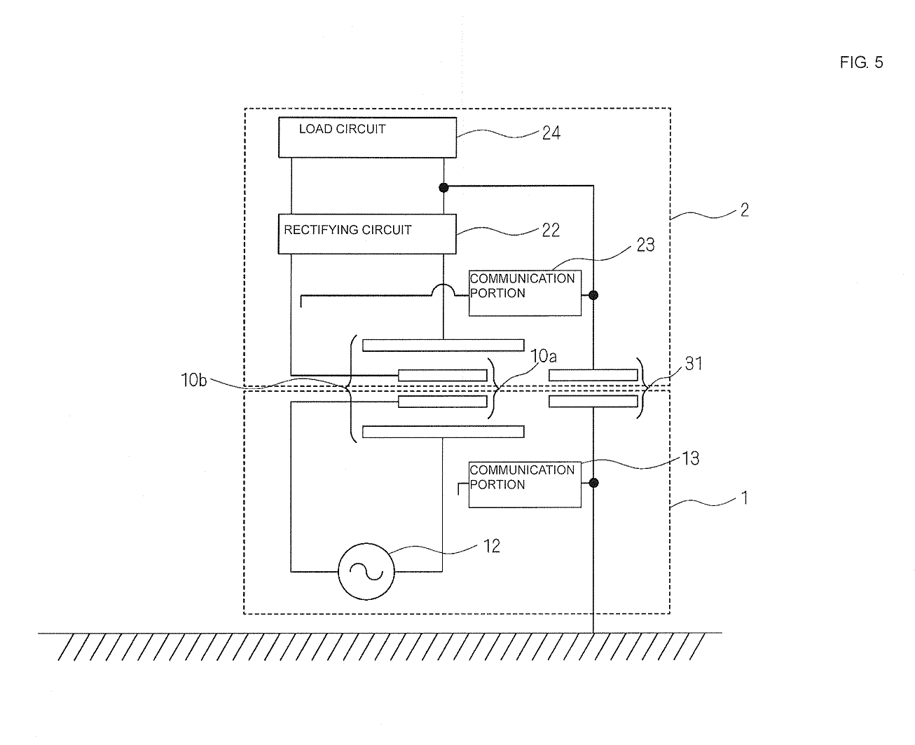

FIG. 5 is a schematic circuit diagram showing another configuration of a power transmission system according to Embodiment 3 of the present invention. In the configuration of the power transmission system shown in FIG. 4, the power transmitting apparatus 1-side and power receiving apparatus 2-side coupling electrodes of each of the first coupling electrode pair 10a and the second coupling electrode pair 10b are formed so as to be adjacent to and face each other. In contrast, in the configuration of the power transmission system shown in FIG. 5, the power transmitting apparatus 1-side and power receiving apparatus 2-side coupling electrodes of the first coupling electrode pair 10a are formed so as to be adjacent to and face each other, and the power transmitting apparatus 1-side and power receiving apparatus 2-side coupling electrodes of the second coupling electrode pair 10b are formed so as to face each other across the first coupling electrode pair 10a.

In FIG. 5 as well, the electrode area of the second coupling electrode pair 10b is larger than the electrode area of the first coupling electrode pair 10a, and, as a result, an asymmetrical configuration is provided in which the first coupling electrode pair 10a having a relatively high potential serves as an active electrode pair and the second coupling electrode pair 10b having a relatively low potential serves as a passive electrode pair. In addition, since the passive electrode pair sandwiches the active electrode pair, the arrangement of the first coupling electrode pair 10a does not need to be as accurate as the configuration shown in FIG. 4.

A second communication portion 23 of the power receiving apparatus 2 is connected at one end thereof to the third coupling electrode pair 31 and is connected at another end thereof via a coupler to the first coupling electrode pair 10a before the rectifying circuit 22. The other end of the second communication portion 23 may be connected to the second coupling electrode pair 10b via the coupler. The power receiving apparatus 2-side third coupling electrode of the third coupling electrode pair 31 is connected to the reference potential of the power receiving apparatus 2, for example, the ground electrode of the circuit board of the power receiving apparatus 2, the shield portion of the housing of the power receiving apparatus 2, or the like.

The voltage generation circuit 12 of the power transmitting apparatus 1 performs a balanced operation, and the power transmitting apparatus 1-side first coupling electrode of the first coupling electrode pair 10a and the power transmitting apparatus 1-side second coupling electrode of the second coupling electrode pair 10b are not connected to the reference potential of the power transmitting apparatus 1. Therefore, even when power transmission is performed at a high voltage, the reference potential of the third coupling electrode pair 31 is more stable than that in the power transmission system according to Embodiment 1.

Power transmission is performed via the first coupling electrode pair 10a and the second coupling electrode pair 10b. Since the one end of the first communication portion 13 and the one end of the second communication portion 23 are connected to the reference potentials as described above, it is possible to greatly reduce change in the reference potentials of the first communication portion 13 and the second communication portion 23 at the time of power transmission, and it is possible to increase the SN ratio of a communication signal. Therefore, it is possible to increase the communication sensitivity and to further stabilize the data communication.

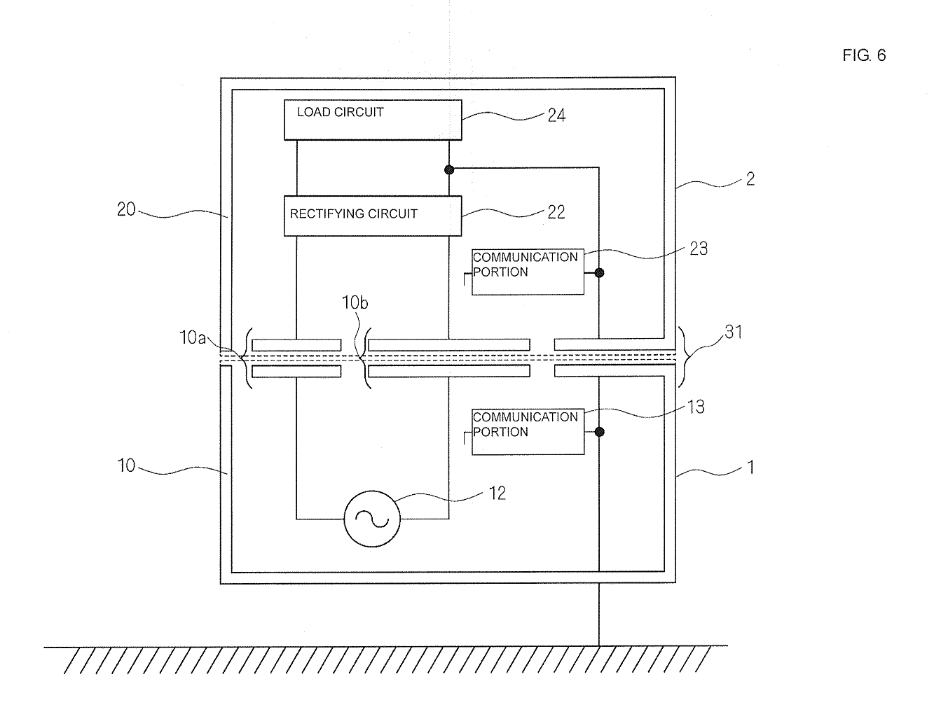

FIG. 6 is a schematic circuit diagram showing still another configuration of a power transmission system according to Embodiment 3 of the present invention. In FIG. 6, a housing 10 of the power transmitting apparatus 1 and a housing 20 of the power receiving apparatus 2 are used as a shield case (a shield portion) for grounding, and the third coupling electrode pair 31, which serves as a reference electrode pair connected to the reference potential, is formed as a portion of the housing 10 of the power transmitting apparatus 1 and a portion of the housing 20 of the power receiving apparatus 2.

The voltage generation circuit 12 of the power transmitting apparatus 1 performs a balanced operation, and the power transmitting apparatus 1-side first coupling electrode of the first coupling electrode pair 10a and the power transmitting apparatus 1-side second coupling electrode of the second coupling electrode pair 10b are not connected to the reference potential of the power transmitting apparatus 1. Therefore, even when power transmission is performed at a high voltage, the reference potential of the third coupling electrode pair 31 is more stable than that in the power transmission system according to Embodiment 1.

Since the third coupling electrode pair 31 is not independently provided and is formed as a portion of the housing 10 of the power transmitting apparatus 1 and a portion of the housing 20 of the power receiving apparatus 2, it is possible to reduce the sizes of the power transmitting apparatus 1 and the power receiving apparatus 2. In addition, the third coupling electrode pair 31 may be located at any position that is within a region where it is possible to place the power receiving apparatus 2 on the power transmitting apparatus 1, and thus flexibility in design is greatly enhanced.

In addition, the other end of the first communication portion 13 of the power transmitting apparatus 1 is connected via a coupler to a power line leading to the second coupling electrode pair 10b having a lower potential among the first coupling electrode pair 10a or the second coupling electrode pair 10b of the power transmitting apparatus 1, and the other end of the second communication portion 23 of the power receiving apparatus 2 is connected via a coupler to a power line leading to the second coupling electrode pair 10b having a lower potential among the first coupling electrode pair 10a or the second coupling electrode pair 10b of the power receiving apparatus 2. Therefore, the first communication portion 13 and the second communication portion 23 are further less subject to influence of potential variation at the time of power transmission, and it is possible to perform more stable data communication at the same time as power transmission.

As described above, according to Embodiment 3, the third coupling electrode pair 31, which is the reference electrode pair, is provided independently of the first coupling electrode pair 10a and the second coupling electrode pair 10b for power transmission, and the one end of the first communication portion 13 of the power transmitting apparatus 1 and the one end of the second communication portion 23 of the power receiving apparatus 2 are connected to the reference potentials of the power transmitting apparatus 1 and the power receiving apparatus 2, respectively. Thus, it is possible to greatly reduce change in the reference potentials of the first communication portion 13 and the second communication portion 23 at the time of power transmission, and it is possible to increase the SN ratio of a communication signal. Therefore, it is possible to perform stable data communication at the same time as power transmission.

### Embodiment 4

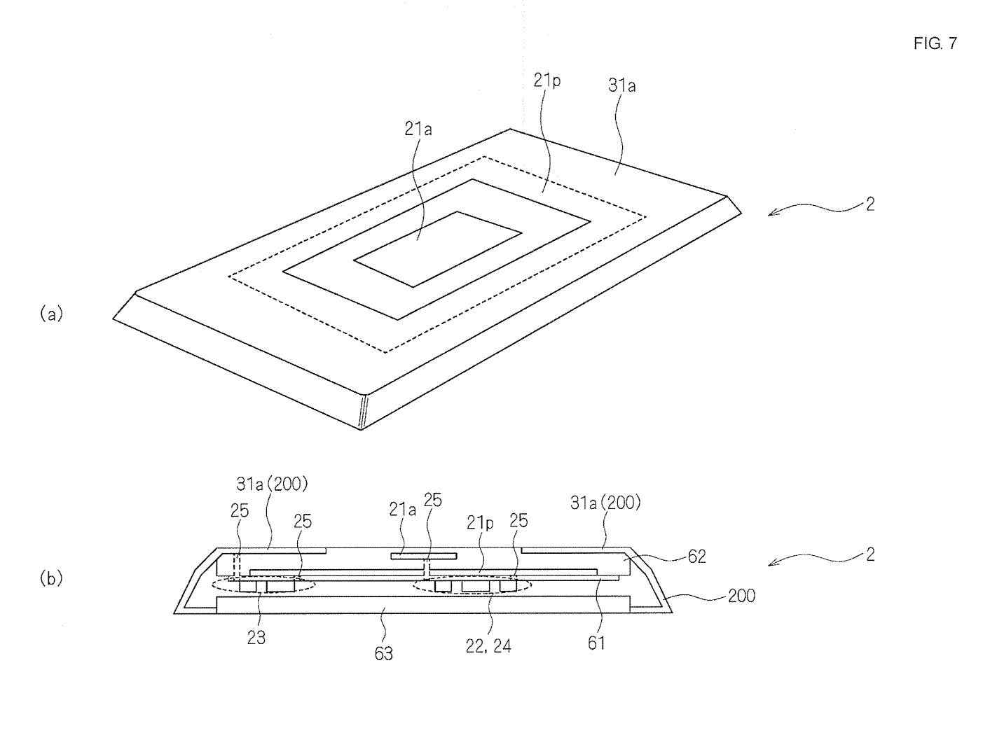

FIG. 7 is a schematic diagram showing a configuration of a smartphone used as a power receiving apparatus 2 of a power transmission system according to Embodiment 4 of the present invention. FIG. 7(a) is a perspective view schematically showing a back-side configuration of the smartphone (power receiving apparatus) 2 according to Embodiment 4 of the present invention, and FIG. 7(b) is a longitudinal cross-sectional view schematically showing a configuration of the smartphone 2 according to Embodiment 4 of the present invention.

As shown in FIG. 7(a), in the smartphone (power receiving apparatus) 2 used in the power transmission system according to Embodiment 4, a power receiving apparatus 2-side first coupling electrode 21a is located in a center portion at a back side, and a power receiving apparatus 2-side second coupling electrode 21p is located inward of the first coupling electrode 21a. A third coupling electrode 31a is located in a peripheral portion at the back side of the smartphone (power receiving apparatus) 2.

As shown in FIG. 7(b), a second communication portion 23, a rectifying circuit 22 connected between the first coupling electrode 21a and the second coupling electrode 21p, and a load circuit 24 are located on a printed circuit board 61 within the smartphone 2. An insulator 62 is provided at a side opposite to a side at which a display portion 63 is provided, that is, at the back side of the smartphone 2, and a portion of a housing 200 which is a conductor is formed on a surface of the insulator 62 so as to serve as the third coupling electrode 31a.

The first coupling electrode 21a and the rectifying circuit 22 are connected to each other via a via electrode 25 extending through the insulator 62 and the printed circuit board 61. Similarly, the second coupling electrode 21p and the rectifying circuit 22 are connected to each other via a via electrode 25 extending through the printed circuit board 61.

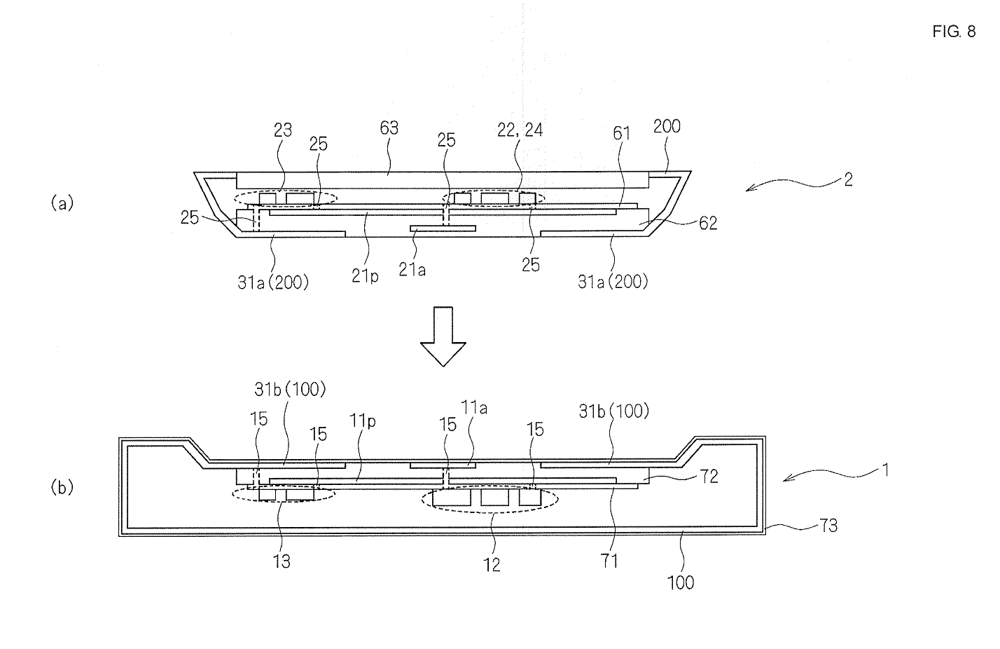

FIG. 8 is a longitudinal cross-sectional view schematically showing a configuration of the power transmission system according to Embodiment 4 of the present invention. FIG. 8(a) is a longitudinal cross-sectional view schematically showing a configuration of the power receiving apparatus 2 of the power transmission system according to Embodiment 4 of the present invention, and FIG. 8(b) is a longitudinal cross-sectional view schematically showing a configuration of a power transmitting apparatus 1 of the power transmission system according to Embodiment 4 of the present invention. In the power transmitting apparatus 1 of the power transmission system according to Embodiment 4, a power transmitting apparatus 1-side first coupling electrode 11a is located on a surface on which the power receiving apparatus 2 is to be placed. In other words, the first coupling electrode 11a is located in a center portion of the surface on which the power receiving apparatus 2 is to be placed, and a second coupling electrode 11p is located inward of the first coupling electrode 11a. A third coupling electrode 31b is located in a peripheral portion of the surface on which the power receiving apparatus 2 is to be placed.

A first communication portion 13 and a voltage generation circuit 12 are located on a printed circuit board 71 within the power transmitting apparatus 1. An insulator 72 is provided at a side at which the power receiving apparatus 2 is to be placed, and a portion of a housing 100 which is a conductor is formed on a surface of the insulator 72 so as to serve as the third coupling electrode 31b. The second coupling electrode 11p having a large electrode area is located within the power transmitting apparatus 1, and the first coupling electrode 11a having a small electrode area is located at the side at which the power receiving apparatus 2 is to be placed. The first coupling electrode 11a and the voltage generation circuit 12 are connected to each other via a via electrode 15 extending through the insulator 72 and the printed circuit board 71. Similarly, the second coupling electrode 11p and the voltage generation circuit 12 are connected to each other via a via electrode 15 extending through the printed circuit board 71.

In Embodiment 4, similarly to Embodiments 1 to 3, a first coupling electrode pair 10a is formed of the power transmitting apparatus 1-side first coupling electrode 11a and the power receiving apparatus 2-side first coupling electrode 21a, and a second coupling electrode pair 10b is formed of the power transmitting apparatus 1-side second coupling electrode 11p and the power receiving apparatus 2-side second coupling electrode 21p. In addition, a third coupling electrode pair 31 is formed of the power transmitting apparatus 1-side third coupling electrode 31b (the portion of the housing 100) and a power receiving apparatus 2-side third coupling electrode 31a (the portion of the housing 200). The power transmitting apparatus 1-side first coupling electrode 11a and the third coupling electrode 31b (the portion of the housing 100) are covered with an insulator 73 to be insulated. It should be noted that the power receiving apparatus 2-side third coupling electrode 31a (the portion of the housing 200) and the first coupling electrode 21a may be covered with an insulator to be insulated, which is not shown.

As shown in FIG. 8, the first coupling electrodes 11a and 21a are formed so as to be adjacent to and face each other when the power receiving apparatus 2 is placed. The second coupling electrodes 11p and 21p are formed so as to face each other across the first coupling electrodes 11a and 21a when the power receiving apparatus 2 is placed. When the electrode areas of the second coupling electrodes 11p and 21p are made larger than the electrode areas of the first coupling electrodes 11a and 21a, it is possible to provide an asymmetrical configuration in which the first coupling electrodes 11a and 21a having a relatively high potential serve as active electrodes and the second coupling electrodes 11p and 21p having a relatively low potential serve as passive electrodes. Due to such an asymmetrical configuration, it is possible to increase the allowance for position shift in the facing surface direction in transmitting and receiving power as compared to the case with a symmetrical configuration in which each of the first coupling electrode pair 10a and the second coupling electrode pair 10b serves as an active electrode pair having a high potential. In addition, an electric field emitted outward from the active electrode having a higher potential is blocked by the passive electrode having a low potential, and thus it is possible to reduce the outward emission of the electric field.

The third coupling electrode 31b and the first communication portion 13 of the power transmitting apparatus 1 are connected to each other via a via electrode 15 extending through the insulator 72 and the printed circuit board 71. Another end of the first communication portion 13 of the power transmitting apparatus 1 is connected to the second coupling electrode 11p via a coupler. The third coupling electrode 31a and the second communication portion 23 of the power receiving apparatus 2 are connected to each other via a via electrode 25 extending through the insulator 62 and the printed circuit board 61. Another end of the second communication portion 23 of the power receiving apparatus 2 is connected to the second coupling electrode 21p via a coupler. By the second coupling electrodes 11p and 21p being coupled via an electric field to each other, it is possible to perform data communication between the power transmitting apparatus 1 and the power receiving apparatus 2.

As described above, according to Embodiment 4, even when power transmission is performed with the first coupling electrode 11a of the power transmitting apparatus 1 and the first coupling electrode 21a of the power receiving apparatus 2 being set at a high potential, the first communication portion 13 and the second communication portion 23 one end of each of which is connected to the reference potential are less subject to influence of potential variation at the time of power transmission, and it is possible to perform stable data communication and power transmission at the same time. In addition, the other end of the first communication portion 13 of the power transmitting apparatus 1 is connected via a coupler to the second coupling electrode 11p having a lower potential among the power transmitting apparatus 1-side first coupling electrode 11a or second coupling electrode 11p, and the other end of the second communication portion 23 of the power receiving apparatus 2 is connected via a coupler to the second coupling electrode 21p having a lower potential among the power receiving apparatus 2-side first coupling electrode 21a or second coupling electrode 21p. Thus, the first communication portion 13 and the second communication portion 23 are further less subject to influence of potential variation at the time of power transmission, and it is possible to perform more stable data communication at the same time as power transmission.

In addition, the present invention is not limited to the above-described embodiments, and it is needless to say that various modifications, various substitutions, or the like may be made without departing from the spirit of the present invention.

### REFERENCE SIGNS LIST

1 power transmitting apparatus
2 power receiving apparatus
10a first coupling electrode pair
10b second coupling electrode pair
12 voltage generation circuit
13 first communication portion
22 rectifying circuit
23 second communication portion
24 load circuit
31 third coupling electrode pair
100, 200 housing

1. A power transmission system comprising:
a power transmitting apparatus including:
power transmitting first, second and third coupling electrodes,
a voltage generation circuit coupled to the first and second coupling electrodes, and
a first communication portion configured to communicate data; and
a power receiving apparatus including:
power receiving first, second and third coupling electrodes,
a load circuit coupled to the first and second coupling electrodes, and
a second communication portion configured to communicate data,
wherein the power receiving first, second and third coupling electrodes are disposed in the power receiving apparatus to form first, second and third coupling electrode pairs with the power transmitting first, second and third coupling electrodes,
wherein the third coupling electrode pair is a reference electrode pair coupled to a reference potential,
wherein the first communication portion includes a first end coupled to a reference potential of the power transmitting apparatus and a second end coupled to either the power transmitting first or second coupling electrode, and
wherein the second communication portion includes a first end coupled to a reference potential of the power receiving apparatus and a second end coupled to the power receiving first or second coupling electrode.

2. The power transmission system according to claim 1, wherein the power transmitting apparatus transmits power to the power receiving apparatus by capacitive coupling.

3. The power transmission system according to claim 1, wherein the reference potential of the power transmitting apparatus is a ground potential.

4. The power transmission system according to claim 1, wherein the first end of the first communication portion is coupled to the power transmitting third coupling electrode, and the first end of the second communication portion is coupled to the power receiving third coupling electrode.

5. The power transmission system according to claim 4, wherein the second end of the first communication portion is coupled to either the power transmitting first or second coupling electrode via a first coupler, and the second end of the second communication portion is coupled to either the power receiving first or second coupling electrode via a second coupler.

6. The power transmission system according to claim 5, wherein the second end of the first communication portion is coupled via the first coupler to a low-potential coupling electrode of the power transmitting first or second coupling electrode, and the second end of the second communication portion is coupled via the second coupler to a low-potential coupling electrode of the power receiving first or second coupling electrode.

7. The power transmission system according to claim 1, wherein the power transmitting second coupling electrode is coupled to the reference potential of the power transmitting apparatus.

8. The power transmission system according to claim 4, wherein the power receiving apparatus further comprises a rectifying circuit coupled between the load circuit and the power receiving first and second coupling electrodes.

9. The power transmission system according to claim 8, wherein the first end of the second communication portion is further coupled between the load circuit and the rectifying circuit.

10. The power transmission system according to claim 1, wherein the power transmitting apparatus and the power receiving apparatus each comprise respective housings.

11. The power transmission system according to claim 10, wherein the respective housings each serve as a shield case.

12. The power transmission system according to claim 10, wherein a portion of the housing of the power transmitting apparatus serves as the power transmitting third coupling electrode, and a portion of the housing of the power receiving apparatus serves as the power receiving third coupling electrode.

13. The power transmission system according to claim 12, wherein the power transmitting second coupling electrode has a larger electrode area than the power transmitting first coupling electrode, and the power receiving second coupling electrode has a larger electrode area than the power receiving first coupling electrode.

14. The power transmission system according to claim 13, wherein the first electrode pair forms an active electrode pair and the second electrode pair forms a passive electrode pair.

15. The power transmission system according to claim 1, wherein the power transmitting second coupling electrode has a larger electrode area than the power transmitting first coupling electrode, and the power receiving second coupling electrode has a larger electrode area than the power receiving first coupling electrode.

16. The power transmission system according to claim 1, wherein the first coupling electrode pair are configured to face each other.

17. The power transmission system according to claim 16, wherein the second coupling electrode pair are configured to face each other.

18. The power transmission system according to claim 17, wherein the second coupling electrode pair face each other across the first coupling electrode pair.

19. The power transmission system according to claim 18, wherein the power transmitting second coupling electrode has a larger electrode area than the power transmitting first coupling electrode, and the power receiving second coupling electrode has a larger electrode area than the power receiving first coupling electrode.
